(19) United States
(12) Patent Application Publication
(10) Pub. No.: US 2005/0205123 A1
(43) Pub. Date: Sep. 22, 2005

(54) Collapsible covers and shades

(76) Inventor: Yu Zheng, Walnut, CA (US)

Correspondence Address: Raymond Sun, 12420 Woodhall Way, Tustin, CA, 92782, US

(21) Appl. No.: 10/806,918

(22) Filed: Mar. 22, 2004

(51) Int. Cl. B62C 1/06; B60P 3/42; E04H 15/40

(52) U.S. Cl. 135/126

(57) ABSTRACT

Assemblies and structures are disclosed having one or more collapsible panels that are positioned to cover a variety of objects, including but not limited to boxes, furniture items, lamps, clocks, doors and windows. The panels are provided to act as covers, shades, dividers, partitions or canopies.

### BACKGROUND OF THE INVENTION

1. Field of the Invention

The present invention relates to collapsible structures, and in particular, to covers, shades and similar apparatus that can be used to cover or surround another object, and which may be twisted and folded to reduce the overall size of the assembly to facilitate convenient storage and use.

2. Description of the Prior Art

Collapsible objects have recently become very popular. Examples of such collapsible objects are shown and described in U.S. Pat. No. 5,038,812 (Norman), U.S. Pat. No. 5,467,794 (Zheng) and U.S. Pat. No. 5,560,385 (Zheng) in the form of collapsible structures. These structures can be used as play structures, shelters, tents, and storage structures, among other uses. These structures may be twisted and folded to reduce the overall size of the structures to facilitate convenient storage and use. As such, these structures are being enjoyed by many people in many different applications.

Other examples of collapsible objects include blanket, mat and floating assemblies as illustrated in one or more of U.S. Pat. No. 6,073,283 (Zheng), U.S. Pat. No. 6,170,100 (Le Gette et al.) and U.S. Pat. No. 6,343,391 (Le Gette et al.). These assemblies can be used as blankets, floor mats, and floating mats. These blankets and mats may be twisted and folded to reduce the overall size of the blanket or mat to facilitate convenient storage and use.

Yet other examples of collapsible objects include sunshades, as illustrated in U.S. Pat. No. 4,815,784 (Zheng) and U.S. Pat. No. 5,024,262 (Huang). U.S. Pat. No. 6,192,635 (Zheng) illustrates a large variety of other collapsible objects, while U.S. Pat. No. 6,581,313 (Zheng) illustrates collapsible flags, signage and umbrellas.

### SUMMARY OF THE DISCLOSURE

It is an object of the present invention to provide a cover or shade that can be folded and collapsed into a smaller configuration for convenient storage and transportation.

It is another object of the present invention to provide a collapsible cover or shade for household items, including furniture.

It is yet another object of the present invention to provide collapsible partitions, screens, window covers, door covers, lamp covers, and clock covers.

In order to accomplish the objects of the present invention, there are provided assemblies and structures having one or more collapsible panels that are positioned to cover a variety of objects, including but not limited to boxes, furniture items, lamps, clocks, doors and windows. The panels are provided to act as covers, shades, dividers, partitions or canopies.

### BRIEF DESCRIPTION OF THE DRAWINGS

FIG. 1 is a perspective view of a panel according to the present invention.

FIG. 2 is a cross-sectional view of the panel of FIG. 1 taken from the region A thereof.

FIGS. 3A-3E illustrate how the panel of FIG. 1 can be twisted and folded for compact storage.

FIGS. 4-14 illustrate different embodiments of collapsible structures according to the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

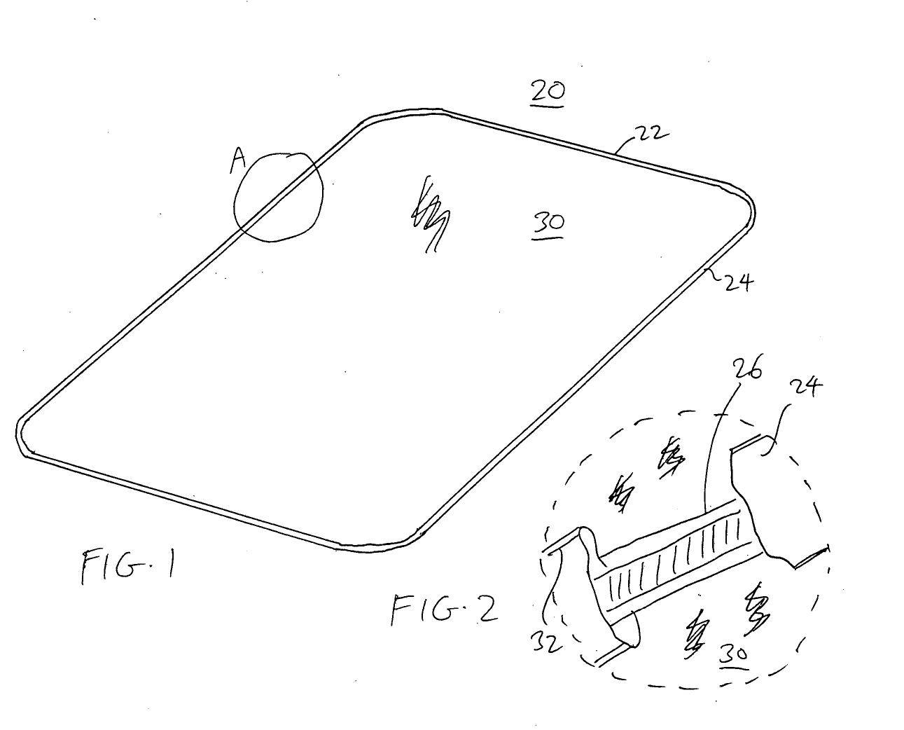

The collapsible structures according to the present invention are configured in the form of one or more basic panels that are assembled together to create a resulting structure having the desired shape and size. FIGS. 1 and 2 illustrate the construction of a basic panel 20. The panel 20 is shown as having four sides, but can be configured to have any number of sides, depending on the desired shape (e.g., circular, oval, or rectangular, square, trapezoidal, or irregular). The panel 20 has a peripheral edge 22 that extends all the way around the panel 20. A peripheral frame retaining sleeve 24 is provided along and traverses the peripheral edge 22, and a continuous frame member 26 is retained or held within the frame retaining sleeve 24 such that the frame member 24 extends completely around the peripheral edge 22.

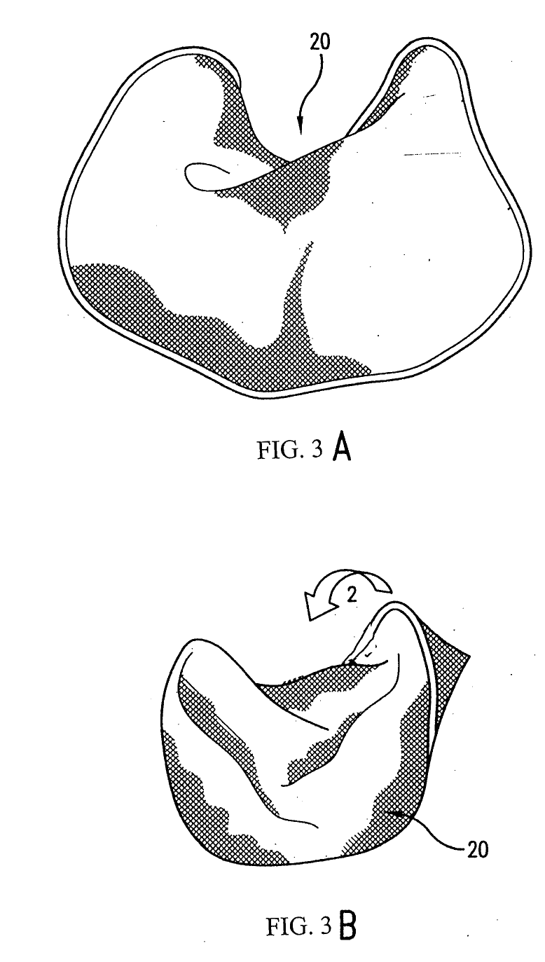

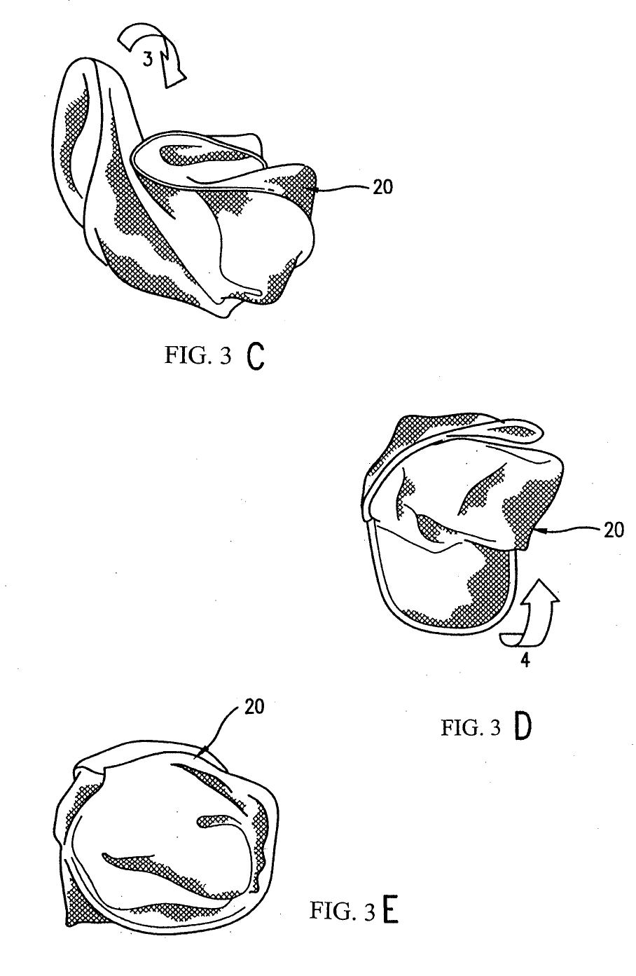

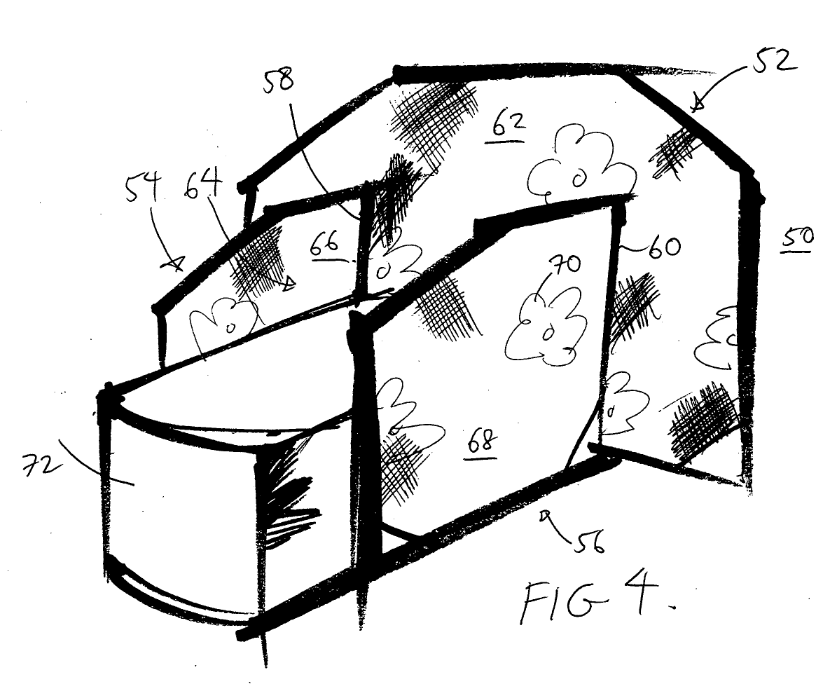

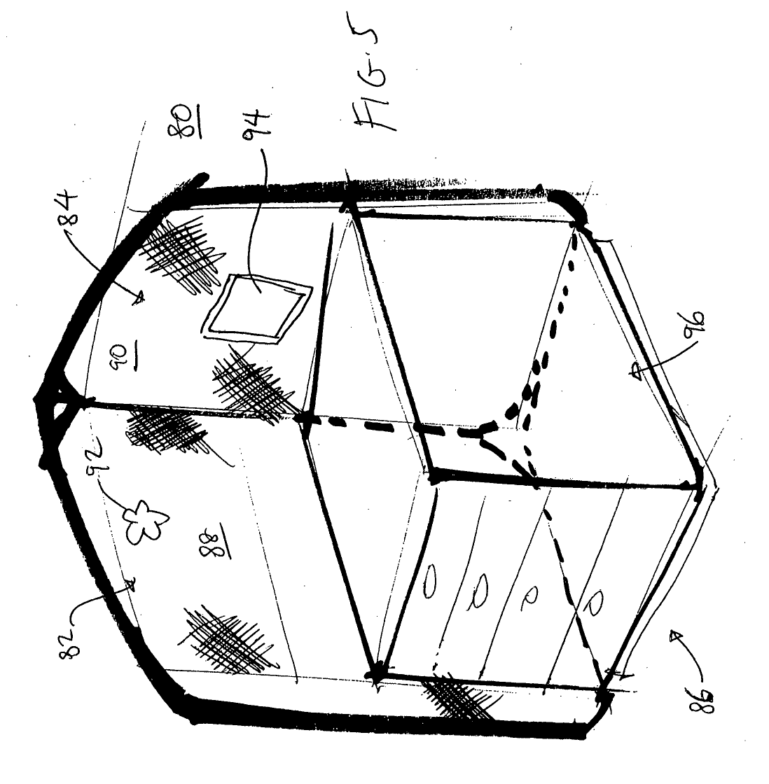

The continuous frame member 26 may be provided as one continuous loop, or may be a strip of material connected at both ends to form a continuous loop. The continuous frame member 26 is preferably formed of flexible coilable steel, although other materials such as plastics may also be used. The frame member 26 should be made of a material which is relatively strong and yet is flexible to a sufficient degree to allow it to be coiled. Thus, the frame member 26 is capable of assuming two positions, an open or expanded position such as shown in FIG. 1, or a folded position (see FIG. 3E) in which the frame member 26 is collapsed into a size which is much smaller than its open position. The frame member 26 may be merely retained within the frame retaining sleeve 24 without being connected thereto. Alternatively, the frame retaining sleeve 24 may be mechanically fastened, stitched, fused, or glued to the frame member 26 to retain the frame member 26 in position.

Sheet material 30 extends across the interior space defined by the sleeve 24, and is held taut by the frame member 26 when the sheet material 30 is in its open position. The term “sheet material” is to be given its broadest meaning and should be made from strong, flexible yet lightweight materials and may include woven fabrics, sheet fabrics, meshed fabrics or even films. The sheet material 30 can be water-resistant and durable to withstand the wear and tear associated with extended use, and rough treatment by adults and children. The peripheral sleeve 24 may attached to the sheet material 30 by a stitching 32. The stitching 32 can also operate to enclose the peripheral sleeve 22. Alternatively, the peripheral sleeve 24 can be a part of or an extension of the sheet material 30, where the outer edge of the sheet material 30 is wrapped around the frame member 26 to enclose the frame member 26, and then a stitching is applied to enclose the sleeve 24.

The panel 20 can then be folded and collapsed into a compact configuration for storage, as illustrated in FIGS. 3A-3E. In the first step illustrated in FIGS. 3A-3C, the opposite border of the panel 20 is folded in to collapse the frame member 26 with the sheet material 30. As shown in FIG. 3D, the next step is to continue the collapsing so that the initial size of the panel 20 is reduced. FIG. 3E shows the next step with the frame member 26 and sheet material 30 collapsed on each other to provide for a small essentially compact configuration having a plurality of concentric frame members 26 and layers of the sheet material 30 so that the collapsed panel 20 has a size which is a fraction of the size of the initial panel 20, as shown in FIG. 3E.

When the frame member 26 is in the collapsed position, the closed loop of the frame member 26 consists of three loop rings intertwined to lie flat. In the collapsed position, the panel 20 will have a significantly reduced diameter which makes it easy to store the collapsed panel 20.

The panel 20 can be expanded again by opening the coiled frame member 26. The bias and resiliency of the frame member 26 will cause the frame member 26 (and the attached sheet material 30) to automatically open out to the expanded position shown in FIG. 1.

FIG. 4 illustrates one embodiment of a collapsible structure 50 according to the present invention. The structure 50 has three separate panels 52, 54 and 56, each having a construction that is the same as the panel 20, but having different shapes. Two of the panels 54, 56 have a side edge 58 and 60, respectively, that is attached to the sheet material 62 of the other panel 52. This attachment can be the same as that which is described in connection with FIGS. 1-3 of U.S. Pat. No. 6,267,128 (Zheng), whose entire disclosure is incorporated by this reference as though set forth fully herein. The two panels 54 and 56 define a space 64 therebetween. Any object or item can be placed in the space 64, or adjacent the outer sides of the panels 54 and 56. For example, FIG. 4 illustrates a box or footlocker 72 that is placed inside the space 64 so as to be completely covered on three of its sides by the three panels 52, 54, 56. In addition to the box 72, a table, a nightstand or other piece of furniture can also be placed inside the space 64 so as to be completely covered on its three sides by the three panels 52, 54, 56. The outer surface of the sheet materials 62, 66 and 68, of the panels 52, 54, 56, respectively, can be provided with any desired ornamental pattern, design, logo, or emblem 70 for decorative purposes.

Thus, the structure 50 can be used as a furniture cover, where the panels 50, 52, 54 are used to cover some of the sides of a table, chair, box or bed (among other types of furniture) so that other people can only see the decorative sides defined by the panels 50, 52, 54. As a result, the user can vary the decorative designs for a piece of furniture by purchasing a plurality of structures 50 (each having different designs) and using different structures 50 at different times. This is an especially cost-effective way for decorating simple furniture, or allowing a piece of furniture to blend into the colors and designs of the rest of the furniture or paint colors in a room. For example, a simple and aesthetically unpleasant (e.g., unfinished) side table or box can be decorated by alternating different structures 50 having different designs, or blended into a new room (or among other furniture items) by providing a structure 50 having a matching color or design.

The structure 50 can be collapsed into a smaller configuration by folding the panels 54, 56 flat onto the panel 52, and then twisting and folding the entire structure 50 using the principles illustrated in FIGS. 3A-3E.

FIG. 5 illustrates another embodiment of a collapsible structure 80 according to the present invention that can also perform the same functions as the structure 50 in FIG. 4. The structure 80 has two separate panels 82, 84, each having a construction that is the same as the panel 20, but having different shapes. The panels 82, 84 are hingedly connected to each other along a side edge thereof. This hinged connection can be the same as that which is described in connection with FIGS. 1 and 3A-3F of U.S. Pat. No. 5,778,915 (Zheng), or FIGS. 1, 4 and 9-16 of U.S. Pat. No. 6,220,265 (Zheng), whose entire disclosures are incorporated by this reference as though set forth fully herein. As described in U.S. Pat. No. 5,778,915 (Zheng) and U.S. Pat. No. 6,220,265 (Zheng), this hinged connection includes stitching a side edge of one panel to the side edge of another panel. The two panels 82, 84 define a space 86 therebetween when they are upright in a vertical orientation. Any object or item can be placed in the space 86. For example, FIG. 5 illustrates a chest of drawers 96 positioned in the space 86 and having two sides covered by the panels 82 and 84. The inner and outer surfaces of the sheet materials 88 and 90, of the panels 82, 84, respectively, can be provided with any desired ornamental pattern, design, logo, emblem 92 for decorative purposes. Openings 94 can also be provided in one or both of the sheet materials 88 and/or 90.

The structure 80 can be collapsed into a smaller configuration by folding the panels 82, 84 against each other to form a stack of two flat panels 82, 84, and then twisting and folding the entire structure 80 using the principles illustrated in FIGS. 3A-3E.

Not only can the structure 80 be used as a furniture cover for a table, chair or bed (among other types of furniture), the structure 80 can even be positioned in an upright position (as shown in FIG. 5) and used as a screen, a partition, or even a play structure, with the opening 94 acting as a window.

In addition, the dimensions of the two panels 82, 84 can be varied so that the two panels 82, 84 do not have to be of the same size or shape. For example, the panels 82, 84 can be provided in different shapes so that they can adequately cover an object that has an irregular shape. As another example, the panels 82, 84 can have different lengths to cover two adjacent sides of a rectangular object. In this regard, the panel 82 in FIG. 5 is slightly wider than the panel 84 so as to adequately cover a rectangular chest of drawers 96.

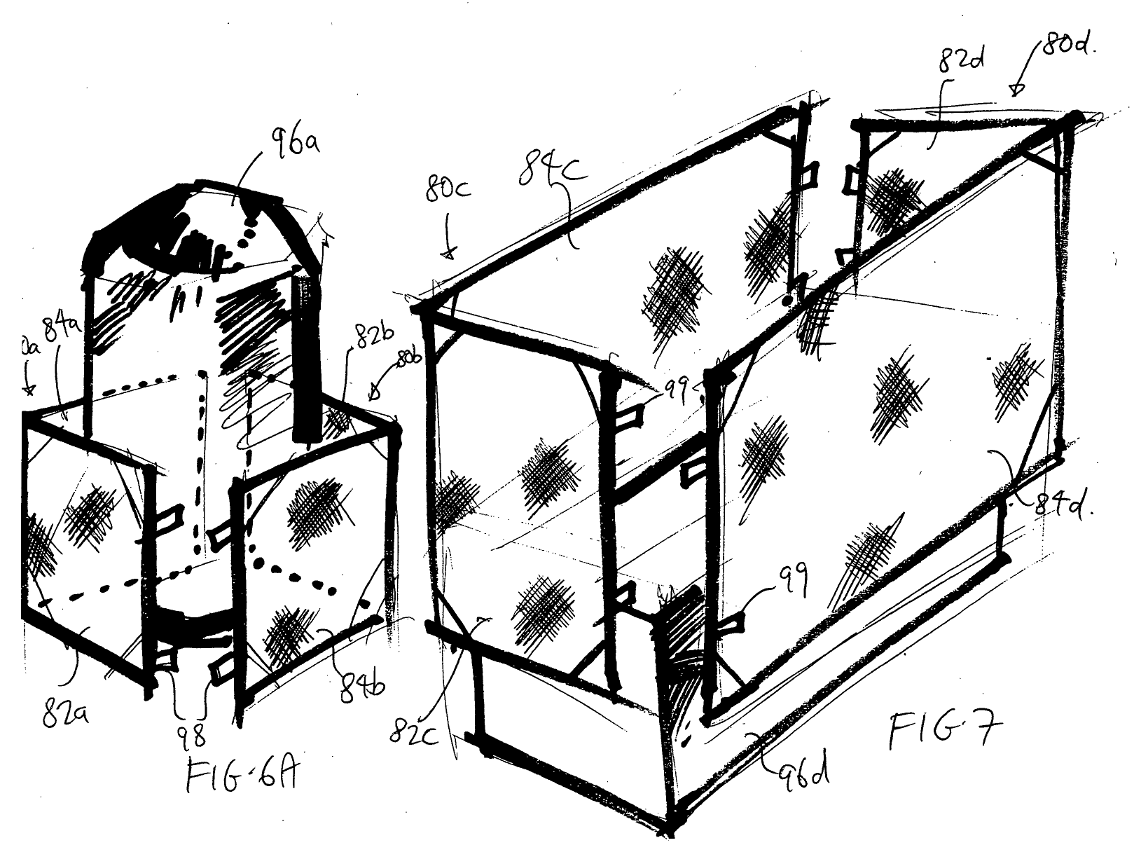

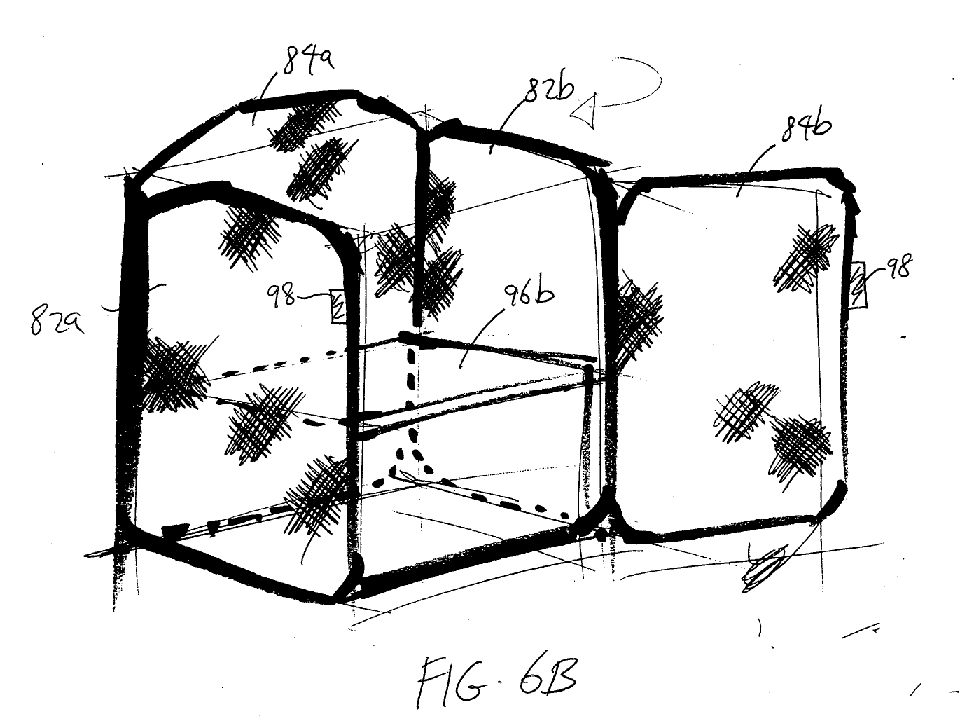

The principles illustrated in FIG. 5 can be modified and extended as shown in FIGS. 6A-12.

Referring first to FIG. 6A, two separate structures 80a and 80b, each of which can be identical in construction (but may have different shapes and sizes) to the structure 80, are provided, and detachable connectors 98 (e.g., hooks, ties, VELCRO™ pieces, etc.) can be provided along the unattached side edges of the panels 82a, 82b, 84a, 84b for removably attaching the two structures 80a, 80b together. When the structures 80a, 80b are attached in this manner, they can be used to completely cover the four sides of any four-sided object or furniture 96a (e.g., bed, table, chair, cabinet, etc.).

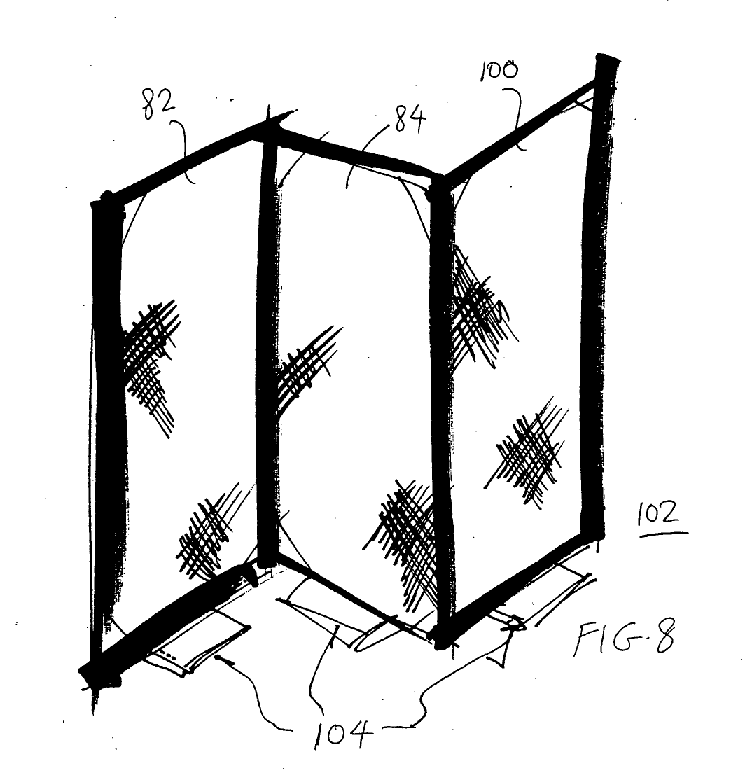

Similarly, in FIG. 7, two separate structures 80c and 80d are provided, each of which is the same in construction as the structure 80 except that they are provided in different shapes. Here, the panels 84c, 84d are wider than the panels 82c, 82d. Detachable connectors 99 (e.g., hooks, ties, VELCRO™ pieces, etc.) can be provided along the unattached side edges of the panels 82c, 82d, 84c, 84d for removably attaching the two structures 80c, 80d together. When the structures 80c, 80d are attached in this manner, they can also be used to completely cover the four sides of any four-sided object or furniture 96d (e.g., bed, table, chair, cabinet, etc.).

The structures in FIGS. 6A and 7 can be further modified by hingedly connecting all four panels together, while leaving one free unattached side in two of the panels. For example, the panels 82a, 84a, 82b, 84b in FIG. 6A can all be hingedly attached to each other, with each of the panels 82a and 84b having one free unattached side that has connectors 98 provided therealong for connecting the two panels 82a, 84b when necessary. This is illustrated in FIG. 6B, with the panels 82a, 84a, 82b, 84b covering an object 96b.

FIG. 8 illustrates a structure 102 where another panel 100 is hingedly connected (using any of the hinged connections described above) to the panel 84 of the structure 80 in FIG. 5. Another way to look at the structure 102 is that it is a modification of FIG. 6B with the panel 84b removed or omitted. Weights 104 can be attached to the bottom side of each panel 82, 84, 100 so that the structure 102 can be used as a screen or partition that separates the space within a room or open area, or to separate different objects or furniture items. Although only FIG. 8 shows the provision of weights 104, weights 104 can be provided at any desired location on any of the panels illustrated in any of the embodiments of the present invention.

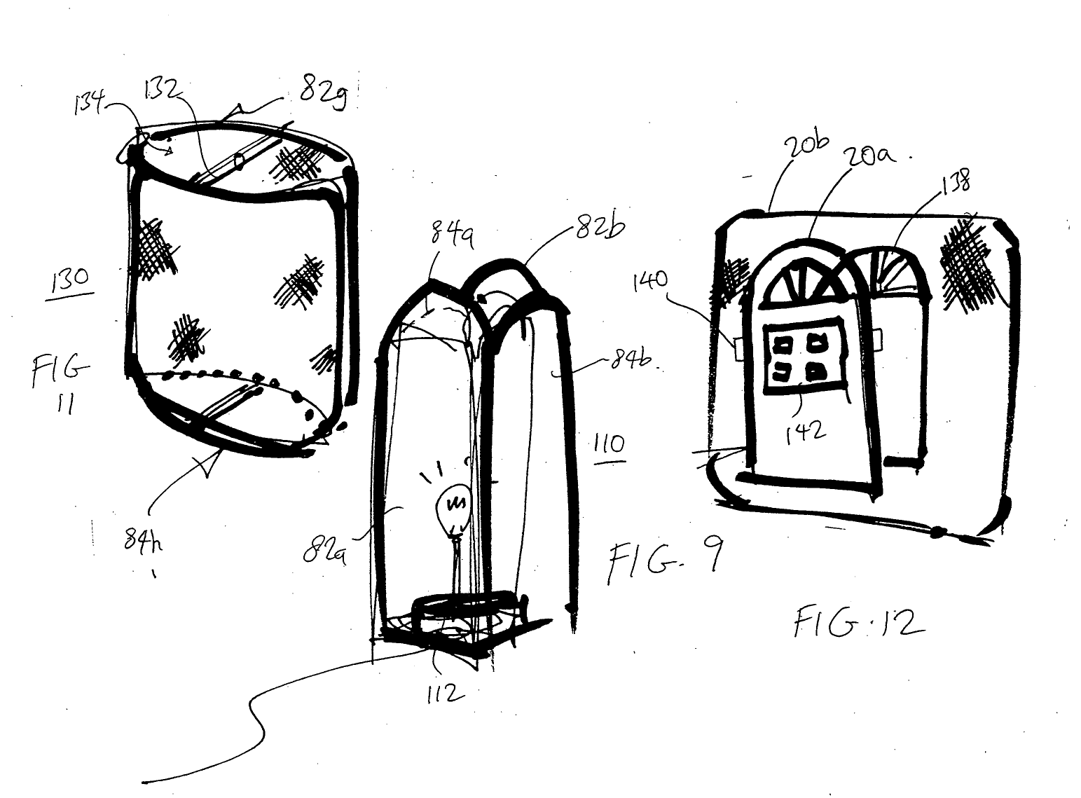

The structures in FIGS. 6A-7 can be further modified by hingedly connecting all four panels together to form a ring of flat panels. For example, the panels 82a, 84a, 82b, 84b in FIG. 6A can all be hingedly attached to each other in the same manner as described in U.S. Pat. No. 5,301,705 (Zheng) or U.S. Pat. No. 5,816,279 (Zheng), whose entire disclosures are incorporated by this reference as though set forth fully herein. For example, FIG. 9 illustrates a lamp cover 110 which is formed by a ring of four panels, such as panels 82a, 84a, 82b, 84b in FIG. 6A, where all the sides of the panels 82a, 84a, 82b, 84b are hingedly connected to a side of an adjacent panel. Here, the user can purchase a single lamp base 112 and a plurality of lamp covers 110 having different shapes, sizes, colors and decorations, so that the user can change the look of the lamp on different occasions, or as desired. The lamp cover 110 can be collapsed by folding the four panels 82a, 84a, 82b, 84b on top of each other in the manner described in U.S. Pat. No. 5,816,279 (Zheng) to form a stack of panels, and then applying the steps illustrated in FIGS. 3A-3E.

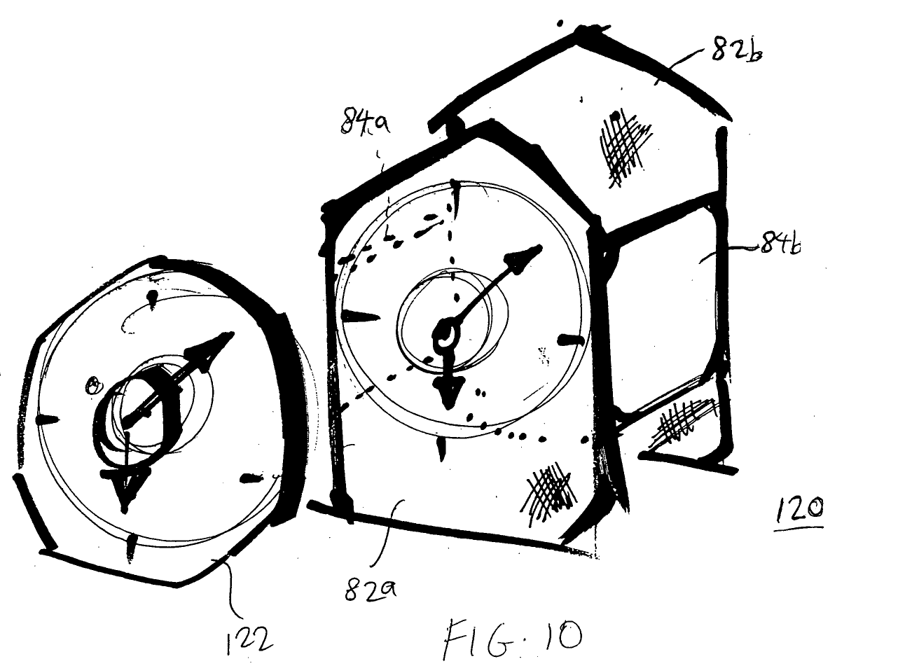

Similarly, FIG. 10 illustrates a clock support 120 which is also formed by a ring of four panels, such as panels 82a, 84a, 82b, 84b in FIG. 6A, where all the sides of the panels 82a, 84a, 82b, 84b are hingedly connected to a side of an adjacent panel. A clock face 122 can be removably coupled (e.g., by VELCRO™ pads, hooks, etc.) to one of the panels 82a, 84a, 82b, 84b. Here, the user can purchase a single clock face 122 and a plurality of clock supports 120 having different shapes, sizes, colors and decorations, so that the user can change the look of the clock on different occasions, or as desired. In addition, FIG. 10 illustrates that the panels 84a, 84b can be made smaller than the panels 82a, 82b to provide the overall clock with a different aesthetic appeal.

The structure 80 in FIG. 5 can be further modified by forming the panels 82, 84 in a curved configuration, and then attaching (either removably or hingedly, as appropriate) the sides of the panels 82, 84. For example, FIG. 11 illustrates a lamp cover 130 that is formed by attaching the sides of the curved panels 82g, 84h. The connected curved panels 82g, 84h define an interior space 134 which is adapted to house or retain a lamp (not shown). Bars or other spacing mechanisms 132 can be positioned between the central portions of the panels 82g, 84h to maintain the panels 82g, 84h in their curved configurations. The cover 130 can be used for other applications (other than as a lamp cover), such as a cage, a basket, and a hamper, among other applications. The cover 130 can be collapsed by removing the spacing mechanism 132, and folding the panels 82g, 84h on top of each other to form a stack of panels, and then applying the steps illustrated in FIGS. 3A-3E.

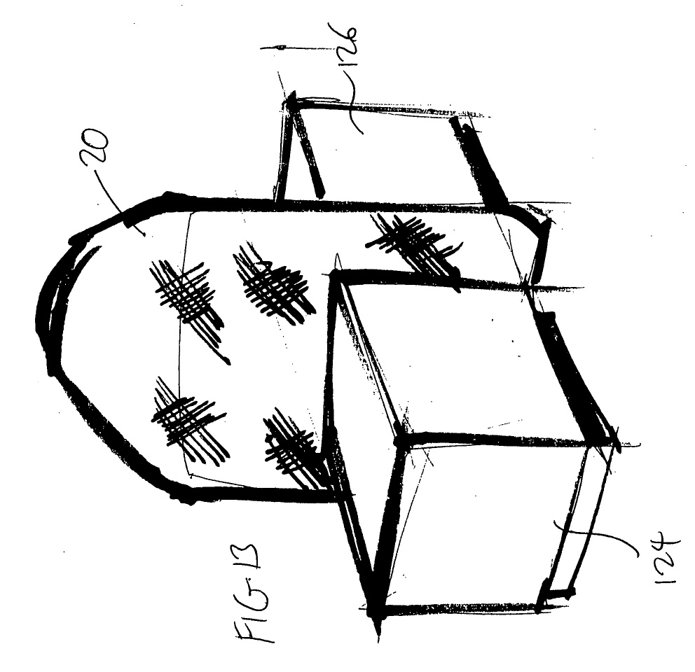

The single panel 20 illustrated in FIGS. 1 and 2 can itself be used as a cover, shade or partition. For example, FIG. 12 illustrates a panel 20a that can have the same construction as the panel 20, with the panel 20a used as a window cover or door cover. Connectors 140 can be provided on the panel 20a to allow the panel 20a to be secured to a window or a door. Openings 142 can be provided in the panel 20a at the location of the actual window or door. The panel 20a can be provided together with another panel 20b to further enhance the aesthetics of a door or window. This panel 20b can have the same construction as the panel 20, and sized larger than the panel 20a, so that the panel 20b can actually be secured to the window or door (using connectors similar to connectors 140), with the panel 20a removably secured to the panel 20b at the location of the door or the window, as shown in FIG. 12. The panel 20b can also have an opening 138 that is aligned with the opening 142. Thus, the panel 20b provides a permanent background or border for a door or window, and the user can removably attach different panels 20a to the background panel 20b to vary the look and feel of the door or window. Additional panels (not shown) having the same construction (but possibly having different shapes and sizes) as the panel 20 can be “sandwiched” between the panels 20a, 20b to enhance or vary the aesthetics of the door or window.

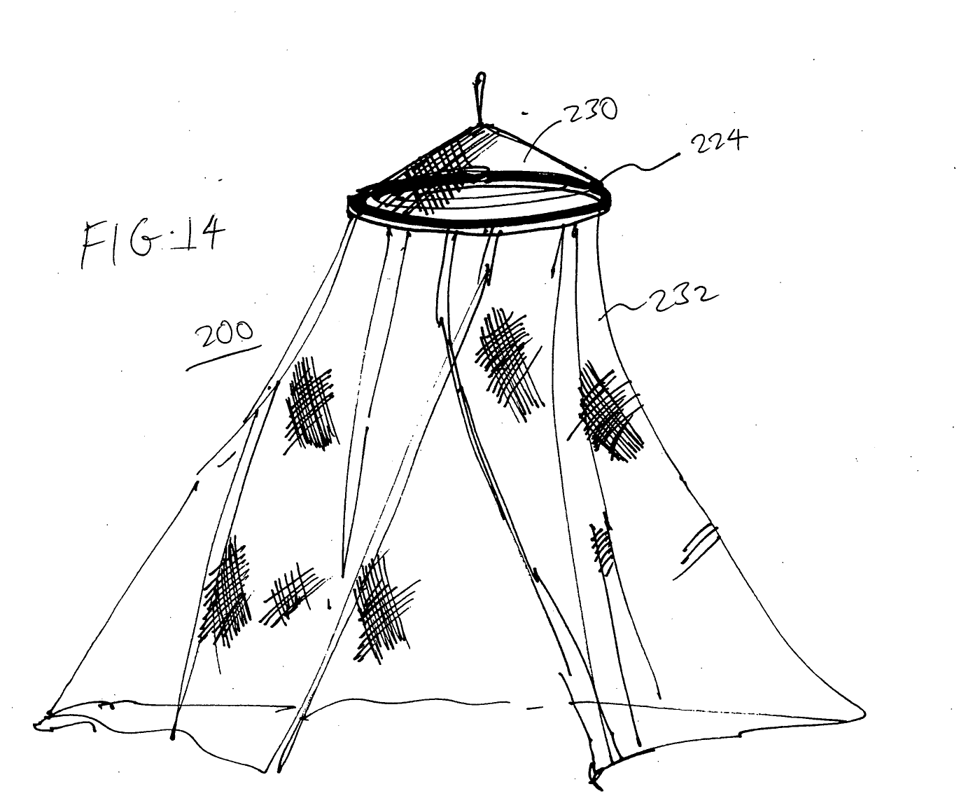

As another example, FIG. 13 illustrates the single panel 20 of FIG. 1 (but having a slightly different shape) in use as a partition or divider between two objects 124 and 126 (e.g., boxes).

FIG. 14 illustrates a collapsible canopy 200 as a different embodiment according to the present invention. The canopy 200 has a frame member (not shown, but the same as frame member 26) that is retained in a peripheral frame retaining sleeve 224. A fabric material 230 extends across the interior space defined by the sleeve 224, and is held loosely by the frame member to define a domed configuration when the fabric material 330 is in its open position. A fabric curtain 232 extends downwardly from the peripheral sleeve 224. The frame member can be collapsed using the techniques illustrated in FIGS. 3A-3E.

While the description above refers to particular embodiments of the present invention, it will be understood that many modifications may be made without departing from the spirit thereof. The accompanying claims are intended to cover such modifications as would fall within the true scope and spirit of the present invention.

1. An assembly, comprising:
a first panel and a second panel, each panel defined by a foldable frame member that has a folded and an unfolded orientation, and a sheet material covering the respective frame member when the respective frame member is in the unfolded orientation, each panel further having a side;
wherein the side of the first panel is hingedly connected at an angle to the side of the second panel to define a space therebetween; and
a solid object positioned in the space and covered by the first and second panels.

2. The assembly of claim 1, wherein each panel has a periphery, and further including a peripheral sleeve extending along the periphery of each panel for retaining the respective frame member.

3. The assembly of claim 1, further including an opening provided in the sheet material of one of the panels.

4. The assembly of claim 1, wherein each frame member forms a plurality of concentric frame members when it has been twisted and folded into the folded orientation.

5. The assembly of claim 1, further including weights attached to each of the panels.

6. An assembly, comprising:
a first panel, a second panel, a third panel and a fourth panel, each panel defined by a foldable frame member that has a folded and an unfolded orientation, and a sheet material covering the respective frame member when the respective frame member is in the unfolded orientation, each panel further having a left side and a right side; and
wherein the right side of the first panel is hingedly connected to the left side of the second panel, the right side of the third panel is hingedly connected to the left side of the fourth panel, the left side of the first panel is removably connected to the right side of the fourth panel, and the right side of the second panel is removably connected to the left side of the third panel.

7. The assembly of claim 6, wherein the four panels are connected together to form a ring of panels that define a space therebetween; and
a solid object positioned in the space.

8. The assembly of claim 6, wherein each panel has a periphery, and further including a peripheral sleeve extending along the periphery of each panel for retaining the respective frame member.

9. The assembly of claim 6, wherein each frame member forms a plurality of concentric frame members when it has been twisted and folded into the folded orientation.

10. The assembly of claim 6, wherein the first and third panels have a first size, and the second and fourth panels have a second size that is different from the first size.

11. The assembly of claim 6, wherein the first and third panels have a first shape, and the second and fourth panels have a second shape that is different from the first shape.

12. An assembly, comprising:
a first panel, a second panel, a third panel and a fourth panel, each panel defined by a foldable frame member that has a folded and an unfolded orientation, and a sheet material covering the respective frame member when the respective frame member is in the unfolded orientation, each panel further having a left side and a right side; and
wherein the right side of the first panel is hingedly connected to the left side of the second panel, the right side of the third panel is hingedly connected to the left side of the fourth panel, the left side of the first panel is hingedly connected to the right side of the fourth panel, and the right side of the second panel is removably connected to the left side of the third panel.

13. The assembly of claim 12, wherein the four panels are connected together to form a ring of panels that define a space therebetween; and
a solid object positioned in the space.

14. The assembly of claim 12, wherein each panel has a periphery, and further including a peripheral sleeve extending along the periphery of each panel for retaining the respective frame member.

15. The assembly of claim 12, wherein each frame member forms a plurality of concentric frame members when it has been twisted and folded into the folded orientation.

16. An assembly, comprising:
a first panel, a second panel and a third panel, each panel defined by a foldable frame member that has a folded and an unfolded orientation, and a sheet material covering the respective frame member when the respective frame member is in the unfolded orientation, each panel further having a left side and a right side; and
wherein the right side of the first panel is hingedly connected to the left side of the second panel, the right side of the second panel is hingedly connected to the left side of the third panel, with the left side of the first panel and the right side of the third panel being uncoupled to any other panel.

17. The assembly of claim 16, further including weights attached to each of the panels.

18. The assembly of claim 16, wherein each frame member forms a plurality of concentric frame members when it has been twisted and folded into the folded orientation.

19. An assembly, comprising:
a first panel, a second panel, a third panel and a fourth panel, each panel defined by a foldable frame member that has a folded and an unfolded orientation, and a sheet material covering the respective frame member when the respective frame member is in the unfolded orientation, each panel further having a left side and a right side;
wherein the right side of each panel is hingedly connected to the left side of an adjacent panel to form a ring of panels that define a space therebetween; and
a solid object positioned in the space.

20. The assembly of claim 19, wherein each panel has a periphery, and further including a peripheral sleeve extending along the periphery of each panel for retaining the respective frame member.

21. The assembly of claim 19, wherein each frame member forms a plurality of concentric frame members when it has been twisted and folded into the folded orientation.

22. A clock, comprising:
at least a first panel and a second panel, each panel defined by a foldable frame member that has a folded and an unfolded orientation, and a sheet material covering the respective frame member when the respective frame member is in the unfolded orientation, each panel further having a left side and a right side;
wherein the right side of the first panel is coupled to the left side of the second panel; and
a clock face removably coupled to the sheet material of one of the panels.

23. The clock of claim 22, wherein the at least a first panel and a second panel further comprises a third panel that is defined by a foldable frame member that has a folded and an unfolded orientation, and a sheet material covering the frame member of the third panel when the frame member of the third panel is in the unfolded orientation, with the third panel further having a left side and a right side; and
wherein the right side of each panel is hingedly connected to the left side of an adjacent panel to form a ring of panels that define a space therebetween.

24. The clock of claim 22, wherein each frame member forms a plurality of concentric frame members when it has been twisted and folded into the folded orientation.

25. A lamp, comprising:
a first panel and a second panel, each panel defined by a foldable frame member that has a folded and an unfolded orientation, and a sheet material covering the respective frame member when the respective frame member is in the unfolded orientation, each panel further having a left side and a right side;
wherein the right side of each panel is connected to the left side of an adjacent panel to form a space therebetween; and
a light emitting element positioned in the space.

26. The lamp of claim 25, wherein the right side of the first panel is connected to the left side of the second panel, and the left side of the first panel is connected to the right side of the second panel, with the first and second panels being curved when the respective frame members are in the unfolded orientation.

27. The lamp of claim 26, further including a spacing mechanism provided between the first and second panels to define the space.

28. The lamp of claim 25, wherein each frame member forms a plurality of concentric frame members when it has been twisted and folded into the folded orientation.

29. A door or window assembly, comprising:
a door or window;
a single panel defined by a foldable frame member that has a folded and an unfolded orientation, and a sheet material covering the frame member when the frame member is in the unfolded orientation, with an opening provided in the sheet material corresponding to the door or window;
means for securing the panel to the door or window.

30. The lamp of claim 29, wherein the frame member forms a plurality of concentric frame members when it has been twisted and folded into the folded orientation.

31. The assembly of claim 29, wherein the single panel is a first panel, further including a second panel defined by a foldable frame member that has a folded and an unfolded orientation, and a sheet material covering the frame member of the second panel when the frame member of the second panel is in the unfolded orientation, with an opening provided in the sheet material of the second panel corresponding to the door or window, with the second panel positioned between the first panel and the door or window.

32. A collapsible structure, comprising:
a first panel and a second panel, each panel defined by a foldable frame member that has a folded and an unfolded orientation, and a sheet material covering the respective frame member when the respective frame member is in the unfolded orientation;
the first panel further including a first side that is stitched to the sheet material of the second panel by a stitching; and
a solid object having a first side positioned adjacent the first panel and a second side positioned adjacent the second panel.

33. The assembly of claim 32, wherein each panel has a periphery, and further including a peripheral sleeve extending along the periphery of each panel for retaining the respective frame member.

34. The assembly of claim 32, wherein each frame member forms a plurality of concentric frame members when it has been twisted and folded into the folded orientation.

35. The assembly of claim 32, further including a third panel defined by a foldable frame member that has a folded and an unfolded orientation, and a sheet material covering the frame member of the third panel when the frame member of the third panel is in the unfolded orientation, the third panel further including a first side that is stitched to the sheet material of the second panel by a stitching; and
wherein the solid object has a third side positioned adjacent the third panel.

36. A cover, comprising:
a foldable frame member that has a folded and an unfolded orientation, the frame member defining a periphery in the unfolded orientation;
a sheet material covering the frame member in a loose manner when the frame member is in the unfolded orientation; and
a curtain extending downwardly from the periphery of the frame member.
